(19) United States
(12) Patent Application Publication
(10) Pub. No.: US 2021/0160056 A1
(43) Pub. Date: May 27, 2021

(54) METHOD AND APPARATUS FOR DECENTRALIZED TRUST EVALUATION IN A DISTRIBUTED NETWORK

(71) Applicant: Nokia Technologies Oy, Espoo (FI)

(72) Inventor: Zheng Yan, Espoo (FI)

(21) Appl. No.: 17/058,058

(22) PCT Filed: Jun. 1, 2018
(86) PCT No.: PCT/CN2018/089497

§ 371 Date: Nov. 23, 2020

(51) Int. Cl. H04L 9/06; H04L 9/30; H04L 9/32; H04L 29/08

(52) U.S. Cl. CPC H04L 9/0637; H04L 9/3073; H04L 9/3297; H04L 2209/56; H04L 67/1097; H04L 2209/38; H04L 9/3239

(57) ABSTRACT

A method and apparatus for decentralized trust evaluation in a distributed network. A method for decentralized trust evaluation in a distributed network comprises obtaining a current block of a blockchain, wherein the current block of the blockchain comprises the hash value of the previous block of the blockchain, a timestamp of creation of the current block, a token issued to a node that creates the previous block of the blockchain, a trust value list indicating current trust values of each of the plurality of nodes, and information indicating evidence based on which the trust values in the trust value list were derived, the evidence was derived after the previous block of the blockchain was created; and extracting current trust values for at least one node of the plurality of nodes from the current block. The method can further comprise steps of collecting the new evidence, creating a new block of the blockchain, selecting an approved new block, issuing a token to a winner node, and performing an access control based on the trust value recorded in the blockchain.

### FIELD OF THE INVENTION

The present invention generally relates to security of communication network, and more specifically, to a decentralized trust evaluation in a distributed network.

### BACKGROUND

Social networking has become an essential part of people's life. Without any doubt, trust plays a crucial role in it since it assists people's decision on social activities.

However, building up a real trust relationship and evaluating trust in a decentralized way are still not an easy task, especially among people located in different places without any face to face interaction. This issue becomes more serious and critical in distributed network. In such a social network, different from conventional online social networking, it generally lacks a centralized server to help information collection, social data aggregation and trust/reputation generation. How to realize trust evaluation and authentication in a purely decentralized way is still an open research issue.

Thus, it would be advancement in the art to provide an approach to realize decentralized trust evaluation in communication network, especially in a distributed network.

### SUMMARY

To overcome the problem described above, and to overcome the limitations that will be apparent upon reading and understanding the prior arts, the disclosure provides a method and apparatus for decentralized trust evaluation in a distributed network.

According to one aspect of the disclosure, a method for decentralized trust evaluation in a distributed network is provided. The distributed network comprises a plurality of nodes, the method comprises: obtaining a current block of a blockchain, wherein the current block of the blockchain comprises the hash value of the previous block of the blockchain, a timestamp of creation of the current block, a token issued to a node that creates the previous block of the blockchain, a trust value list indicating current trust values for each of the plurality of nodes, and information indicating evidence based on which the trust values in the trust value list were derived, the evidence was derived after the previous block of the blockchain was created; and extracting current trust values for at least one node of the plurality of nodes from the current block.

In an exemplary embodiment, the method can further comprise deriving new evidence after the current block of the blockchain was created; and sharing the new evidence among the plurality of nodes.

In an exemplary embodiment, deriving the new evidence can further comprise: collecting statistic communication information among the plurality of nodes; and deriving the new evidence based on the statistic communication information among the plurality of nodes and on local trust values on the other nodes of the plurality of nodes.

In an exemplary embodiment, the statistic communication information can further comprise interaction number and communication data volumes among the plurality of nodes.

In an exemplary embodiment, the method can further comprise signing the new evidence with the private key of the node that shares the new evidence.

In an exemplary embodiment, the method can further comprise: creating a new block of the blockchain; and sharing the new block among the plurality of nodes.

In an exemplary embodiment, creating a new block of the blockchain comprises: collecting new evidence, wherein the new evidence was derived after the current block was created; and calculating new trust values for each of the plurality of nodes based on the new evidence.

In an exemplary embodiment, wherein the new trust values for each of the plurality of nodes can be calculated based on the new evidence, in case that the size of the evidence reaches an evidence threshold.

In an exemplary embodiment, calculating new trust values for each of the plurality of nodes based on the new evidence can further comprise: calculating new trust values for each of the plurality of nodes based on the deviation between the new evidence and an average of the new evidence, and the current trust values for each of the plurality of nodes.

In an exemplary embodiment, the method can further comprise verifying the correctness of the new evidence.

In an exemplary embodiment, creating a new block of the blockchain can further comprise inserting a public key of the node that creates the new block into the new block.

In an exemplary embodiment, the method can further comprise inserting the data of the new evidence into the new block.

In an exemplary embodiment, the method can further comprise inserting a pointer for the data of the new evidence and a hash value of the data of the new evidence, wherein the pointer refers to a location from where the data of the new evidence is available, and the data of the new evidence is stored outside the new block.

In an exemplary embodiment, the data of the new evidence can be stored in a cloud storage.

In an exemplary embodiment, the method can further comprise signing the new block with the private key of the node that creates the new block.

In an exemplary embodiment, the method can further comprise: obtaining at least one new block created by at least one node of the plurality of nodes; selecting one winner node from the at least one node of the plurality of nodes, wherein the new block created by the winner node is taken as an approved new block.

In an exemplary embodiment, selecting the approved new block can comprise selecting the winner node based on the creating time at which the nodes create the new blocks.

In an exemplary embodiment, selecting the approved new block can comprise selecting the winner node based on the number of tokens possessed by the node.

In an exemplary embodiment, selecting the approved new block can comprise selecting the winner node based on the trust values of the nodes.

In an exemplary embodiment, selecting the approved new block can comprise selecting the winner node based on the number of node trust values which the node has calculated.

In an exemplary embodiment, selecting the approved new block can comprise selecting the winner node based on the public keys of the nodes.

In an exemplary embodiment, selecting the approved new block can comprise selecting the node that creates the new block at earliest time as the winner node.

In an exemplary embodiment, selecting the node that creates the new block at earliest time as the winner node can comprise selecting the node that creates the new block at earliest time as the winner node, except that the number of tokens possessed by the node goes beyond a token threshold.

In an exemplary embodiment, selecting the approved new block can further comprise selecting the node that creates the new block with highest trust value as the winner node, in case that at least two nodes create new blocks at same time.

In an exemplary embodiment, selecting the node that creates the new block with higher trust value as the winner node can comprise selecting the node that creates the new block with highest trust value as the winner node, except that the number of tokens possessed by the node goes beyond a token threshold.

In an exemplary embodiment, selecting the approved new block can further comprise selecting the node possessing less number of tokens as the winner node, in case that at least two nodes that create the new block have same trust values.

In an exemplary embodiment, selecting the approved new block can further comprise selecting the node that creates the new block that calculates less node trust values as the winner node, in case that the number of tokens possessed by the at least two nodes that create the new block are same.

In an exemplary embodiment, selecting the approved new block can further comprise selecting the node that creates the new block with a biggest or smallest public key as the winner node, in case that at least two nodes that create the new block have calculated same numbers of trust values.

In an exemplary embodiment, the method can further comprise signing the selection result with the private key of the node that shares the selection result.

In an exemplary embodiment, the method can further comprise: obtaining selection results; selecting an approved new block as the next block of the blockchain; and issuing a token to the node that creates the next block.

In an exemplary embodiment, the method can select an approved new block as the next block of the blockchain, in case that the sum of the current trust values of the nodes which select the node that creates the next block as the winner node reaches a trust value threshold.

In an exemplary embodiment, the method can select an approved new block as the next block of the blockchain, in case that the number of the nodes which select the node that creates the next block as the winner node reaches a node threshold.

In an exemplary embodiment, the trust value threshold can be relative to the current trust values of each node and the number of the plurality of the nodes.

In an exemplary embodiment, the node threshold can be relative to the current trust values of each node and the number of the plurality of the nodes.

In an exemplary embodiment, issuing a token to the node that creates the next block can comprise generating the token issued to the node that creates the next block based on the hash value of the current block of the blockchain, the public key of the node that creates the next block, the signatures with the private keys of the nodes that select the node that creates the next block as the winner node, and the public keys of the nodes that select the node that creates the next block as the winner node.

In an exemplary embodiment, the method can further comprise performing an access control to a node based on the current trust value of the node.

In an exemplary embodiment, performing an access control to the node based on the current trust values can comprise allowing an access right to a node whose current trust value meets an access strategy.

In an exemplary embodiment, allowing the access right can comprise encrypting the information to be accessed by an allowed node with the private key of the allowed node based on Attribute-Based Encryption algorithm, Public Key Encryption algorithm, or Homomorphic Encryption algorithm.

In an exemplary embodiment, the distributed network can be a pervasive social network.

In an exemplary embodiment, the new evidence can be relative to a context information.

In an exemplary embodiment, the new trust values of each of the plurality of nodes can be relative to a context information.

In an exemplary embodiment, the context information can be relative to an application of social communication.

In an exemplary embodiment, the context information can be relative to a purpose of social communication.

According to another aspect, an apparatus for decentralized trust evaluation in a distributed network is provided. The distributed network comprises a plurality of nodes. The apparatus comprises: a trust module configured to obtain a current block of a blockchain, wherein the current block of the blockchain comprises the hash value of the previous block of the blockchain, a timestamp of creation of the current block, a token issued to a node that creates the previous block of the blockchain, a trust value list indicating current trust values of each of the plurality of nodes, and information indicating evidence based on which the trust values in the trust value list were derived, the evidence was derived after the previous block of the blockchain was created; and a user interface module configured to extract current trust values for at least one node of the plurality of nodes from the current block and show blockchain information.

In an exemplary embodiment, the apparatus can further comprise: a blockchain management module configured to derive a new evidence after the current block of the blockchain was created; and the trust module can be further configured to share the new evidence among the plurality of nodes.

In an exemplary embodiment, the trust module can be further configured to collect statistic communication information among the plurality of nodes; and the blockchain management module can be further configured to derive the new evidence based on the statistic communication information among the plurality of nodes and on local trust values on the other nodes of the plurality of nodes.

In an exemplary embodiment, the statistic communication information can comprise interaction number and communication data volumes among the plurality of nodes.

In an exemplary embodiment, the apparatus can further comprise a key management module configured to sign the new evidence with the private key of the node that shares the new evidence.

In an exemplary embodiment, the blockchain management module can be further configured to create a new block of the blockchain; and the trust module can be further configured to share the new block among the plurality of nodes.

In an exemplary embodiment, the trust module can be further configured to collect new evidence, wherein the new evidence was derived after the current block was created; and the blockchain management module can be further configured to calculate new trust values for each of the plurality of nodes based on the new evidence.

In an exemplary embodiment, the blockchain management module can be further configured to calculate new trust values for each of the plurality of nodes based on the new evidence, in case that the size of the evidence reaches an evidence threshold.

In an exemplary embodiment, the trust module can be further configured to calculate new trust values for each of the plurality of nodes based on the deviation between the new evidence and an average of the new evidence, and the current trust values for each of the plurality of nodes.

In an exemplary embodiment, the key management module can be further configured to verify the correctness of the new evidence.

In an exemplary embodiment, the key management module can be further configured to insert a public key of the node that creates the new block into the new block.

In an exemplary embodiment, the blockchain management apparatus can be further configured to insert the data of the new evidence into the new block.

In an exemplary embodiment, the blockchain management module can be further configured to insert a pointer for the data of the new evidence and a hash value of the data of the new evidence, wherein the pointer refers to a location from where the data of the new evidence is available, and the data of the new evidence is stored outside the new block.

In an exemplary embodiment, the data of the new evidence can be stored in a cloud storage.

In an exemplary embodiment, the key management module can be further configured to sign the new block with the private key of the node that creates the new block.

In an exemplary embodiment, the trust module can be further configured to obtain at least one new block created by at least one node of the plurality of nodes; the blockchain management module can be further configured to select one winner node from the at least one node of the plurality of nodes, wherein the new block created by the winner node is taken as an approved new block; and the trust module can be further configured to share a selection result among the plurality of nodes.

In an exemplary embodiment, the blockchain management module can be further configured to select the winner node based on the creating time at which the nodes create the new blocks.

In an exemplary embodiment, the blockchain management module can be further configured to select the winner node based on the number of tokens possessed by the node.

In an exemplary embodiment, the blockchain management module can be further configured to select the winner node based on the trust values of the nodes.

In an exemplary embodiment, the blockchain management module can be further configured to select the winner node based on the number of node trust values which the node has calculated.

In an exemplary embodiment, the blockchain management module can be configured to select the winner node based on the public keys of the nodes.

In an exemplary embodiment, the blockchain management module can be configured to select the node that creates the new block at earliest time as the winner node.

In an exemplary embodiment, the blockchain management module can be further configured to select the node that creates the new block at earliest time as the winner node, except that the number of tokens possessed by the node goes beyond a token threshold.

In an exemplary embodiment, the blockchain management module can be further configured to select the node that creates the new block with highest trust value as the winner node, in case that at least two nodes create new blocks at same time.

In an exemplary embodiment, the blockchain management module can be further configured to select the node that creates the new block with highest trust value as the winner node, except that the number of token possessed by the node goes beyond a token threshold.

In an exemplary embodiment, the blockchain management module can be further configured to select the node possessing less number of tokens as the winner node, in case that at least two nodes that create the new block have same trust values.

In an exemplary embodiment, the blockchain management module can be further configured to select the node that creates the new block that calculates less node trust values as the winner node, in case that the number of token possessed by the at least two nodes that create the new block are same.

In an exemplary embodiment, the blockchain management module can be further configured to select the node that creates the new block with a biggest or smallest public key as the winner node, in case that at least two nodes that create the new block have calculated same numbers of trust values.

In an exemplary embodiment, the key management module can be further configured to sign the selection result with the private key of the node that shares the selection result.

In an exemplary embodiment, the trust module can be further configured to obtain selection results; the blockchain management module is further configured to select an approved new block as the next block of the blockchain and issues a token to the node that creates the next block.

In an exemplary embodiment, the blockchain management module can be further configured to select an approved new block as the next block of the blockchain, in case that the sum of the current trust values of the nodes which select the node that creates the next block as the winner node reaches a trust value threshold.

In an exemplary embodiment, the blockchain management module can be further configured to select an approved new block as the next block of the blockchain, in case that the number of the nodes which select the node that creates the next block as the winner node reaches a node threshold.

In an exemplary embodiment, the trust value threshold can be relative to the current trust values of each node and the number of the plurality of the nodes.

In an exemplary embodiment, the node threshold can be relative to the current trust values of each node and the number of the plurality of the nodes.

In an exemplary embodiment, the blockchain management module can be further configured to generate the token issued to the node that creates the next block based on the hash value of the current block of the blockchain, the public key of the node that creates the next block, the signatures with the private keys of all the nodes that select the node that creates the next block as the winner node, and the public keys of all the nodes that select the node that creates the next block as the winner node.

In an exemplary embodiment, the trust module can be further configured to perform an access control to a node based on the current trust value of the node.

In an exemplary embodiment, the trust module can be further configured to allow an access right to a node whose current trust value meets an access strategy.

In an exemplary embodiment, the key management module can be further configured to encrypt the information to be accessed by an allowed node with the private key of the allowed node based on an Attribute-Based Encryption algorithm, a Public Key Encryption algorithm, or a Homomorphic Encryption algorithm.

In an exemplary embodiment, the distributed network can be a pervasive social network.

In an exemplary embodiment, the new evidence can relative to a context information.

In an exemplary embodiment, the new trust values of each of the plurality of nodes can be relative to a context information.

In an exemplary embodiment, the context information can be relative to an application of social communication.

In an exemplary embodiment, the context information can be relative to a purpose of social communication.

In an exemplary embodiment, the apparatus can further comprise an application module configured to provide the context information.

In an exemplary embodiment, the apparatus can further comprise a trust database configured to storing data of the current block of the blockchain.

According to another aspect, an apparatus comprising means for performing a method according to above mentioned method is provided.

According to yet another aspect, a non-transitory computer-readable storage medium that stores instructions which, when executed by one or more processor, cause the processor to perform a method according to abovementioned method is provided.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 illustrates a system model for decentralized trust evaluation in a distributed network according to an embodiment of the present disclosure;

FIG. 2 illustrates a structure of a block of blockchain for decentralized trust evaluation in a distributed network according to an embodiment of the present disclosure;

FIG. 3 illustrates a logical configuration for winner node selection for decentralized trust evaluation in a distributed network according to an embodiment of the present disclosure;

FIG. 4 illustrates a method for decentralized trust evaluation in a distributed network according to an embodiment of the present disclosure;

FIG. 5 illustrates a method for decentralized trust evaluation in a distributed network, especially collecting new evidence, according to an embodiment of the present disclosure;

FIG. 6 illustrates a method for decentralized trust evaluation in a distributed network, especially creating a new block of the blockchain, according to an embodiment of the present disclosure;

FIG. 7 illustrates a method for decentralized trust evaluation in a distributed network, especially selecting an approved new block, according to an embodiment of the present disclosure;

FIG. 8 illustrates a method for decentralized trust evaluation in a distributed network, especially issuing a token to the winner node, according to an embodiment of the present disclosure;

FIG. 9 illustrates a method for decentralized trust evaluation in a distributed network, especially performing an access control, according to an embodiment of the present disclosure;

FIG. 10 illustrates an apparatus for decentralized trust evaluation in a distributed network according to an embodiment of the present disclosure;

FIG. 11 illustrates a computer system upon which an embodiment of the disclosure can be implemented; and

FIG. 12 illustrates a chip set that can be used to implement an embodiment of the disclosure.

### DETAILED DESCRIPTION OF THE INVENTION

Examples of a method and apparatus for decentralized trust evaluation in a distributed network are disclosed. In the following description, for the purposes of explanation, numerous specific details are set forth in order to provide a thorough understanding of the embodiments of the invention. It is apparent, however, to one skilled in the art that the embodiments of the invention can be practiced without these specific details or with an equivalent arrangement. In other instances, well-known structures and devices are shown in block diagram form in order to avoid unnecessarily obscuring the embodiments of the invention.

Heterogeneous networks organized by the Internet, mobile cellular networks and self-organized Mobile Ad hoc Networks (MANETs) have received special attention due to their capabilities of establishing an instant communication platform for time-critical or mission-critical applications. As a concrete application example, Pervasive Social Network (PSN), as a type of the distributed network, supports instant social activities anywhere and at any time in an intelligent and context-aware manner by switching among heterogeneous networks based on user demands. Not only people socially connected, but also strangers physically in proximity can form a social group to perform various social activities in a pervasive way.

The distributed network, such as PSN, is an essential complement to the Internet online social networking with the properties of “anywhere and anytime”, thus very valuable for mobile users. The distributed network, such as PSN, is especially valuable when the Internet online social networks are temporarily unavailable or costly to access. The current trend of distributed network services is decentralizing since a node in distributed network can be both a service provider and a consumer. The distributed network can also provide instant recommendations, fast assistance, and urgent rescues in practice.

Trust evaluation is a technical approach of representing trust for digital processing, in which the factors influencing trust are evaluated by a continuous or discrete real number, referred to as a trust value. Embedding a trust evaluation mechanism is necessary for providing trust intelligence in future computing and networking systems. Trust evaluation is the main aspect in the research of digitalizing trust. In the known art, Bayesian inference, (weighted) average models, Dempster-Shafer theory, subjective logic, fuzzy logic, entropy-based models, fuzzy cognitive maps, game theory, cloud theory, Information Theoretic Framework, PeerTrust, etc. are applied for performing trust evaluation in various fields.

First, the conventional social networking lacks real decentralized trust evaluation. Many existing works on trust evaluation in social networking normally depend on a trusted third party to collect social communication data or social networking behavior data to perform information fusion and aggregation in order to conduct trust evaluation or reputation generation. Trust evaluation at a specific node based on locally collected but incomplete information is normally not accurate, with bias. Reputation generation needs to rely on a single node or party. Thus, trust authentication has to depend on a centralized party. In short, past solutions about trust evaluation and trust authentication are centralized. In the trust evaluation techniques or theories, data collection and processing for trust evaluation in practical usage are mostly centralized. It cannot afford single node attack. One node crash could cause destroy of a whole system. The decentralized solution is particularly needed in IoT, PSN, distributed networking/computing, crowdsourcing and cross-operator services. An effective and purely decentralized trust evaluation and authentication scheme for distributed network or PSN is needed.

Second, the trust evaluation must be trustworthy. The user hopes trust evaluation is transparent, open, traceable and cannot be denied, thus the trustworthiness of trust evaluation can be ensured. However, some existing distributed trust evaluation solutions cannot achieve this goal since people cannot know if the trust evaluation is rational, without any defect. Thus, it is hard to ensure aggregated trust or reputation based on local trust is creditable. How to support public auditing on trust evaluation is still an open problem.

P2P Reputation system is an approach that arises for trust evaluation in distributed network recently. The currently existed representative P2P reputation systems, such as eBay and PeerTrust system, focus on trust management in securing commodity exchanges in e-commerce applications. Other systems focus on generic P2P applications such as P2P file sharing and Web service-based sharing platforms.

The eBay (www.ebay.com) user feedback system applies a centralized database to store and manage the trust scores. Data is open to the general public, so a newcomer can easily obtain a peer score. It's a hybrid P2P system using both distributed client resources and centralized servers. Such system tries to be user friendly by providing a limited amount of data to a user, but on the other hand the provided and processed information is not complete and does not provide a full picture. A distributed reputation system using a Bayesian approach, in which the second-hand reputation rating is accepted only when it is compatible with the primary rating, is also provided. This reputation scheme can detect mis-behavior nodes in ad hoc networks. But this scheme is not transparent, it is impossible to trace and audit the whole process of trust evaluation.

The PeerTrust model is based on a weighted sum of five peer feedback factors: peer records, scope, credibility, transaction context, and community context. PeerTrust is distributed, uses overlay for trust propagation, public-key infrastructure for securing remote scores, and prevents peers from some malicious abuses.

Another system, such as using EigenTrust algorithm, captures peer reputation in the number of satisfactory transactions and then normalizes it over all participating peers. The algorithm aggregates the scores by a weighted sum of all raw reputation scores. The fully distributed system assumes that pre-trusted peers exist when the system is initiated. It uses majority voting to check faulty reputation scores reported. Other researchers also propose many approaches, such as a trusted middleware for P2P applications consisting of two models: the Multiple Currency Based Economic model (M-CUBE) and the Personalized Trust model (PET), and a scheme for trust inference in P2P networks consisting of two parts for local trust inference and distributed search. The M-CUBE model in the trusted middleware for P2P applications provides a general and flexible substrate to support high-level P2P resource management services. PET derives peer trustworthiness from long-term reputation evaluation and short-term risk evaluation. The trust scheme for trust inference in P2P networks, after each transaction, generates cookies to record direct trust between peers. It also uses trust graphs to infer transitive trust along a peer chain.

Credence is a robust and decentralized system for evaluating the reputation of files in a P2P file sharing system (Retrieved from http://www.cs.cornell.edu/people/egs/credence/index.html). Its goal is to enable peers to confidently gauge file authenticity, the degree to which the content of a file matches its advertised description. At the most basic level, Credence employs a simple, network-wide voting scheme where users can contribute positive and negative evaluations of files. On top of this, a client uses statistical tests to weight the importance of votes from other peers. It allows the clients to share selected information with other peers. Privacy is ensured by not collecting or using any personally identifiable information in any way in the protocol. Each Credence-equipped client is supplied with a unique, randomly generated key pair that is not bound to any personal information for use in cryptographic operations.

Regarding social network trust and reputation, the concept of data centric trust in volatile environments, such as ad hoc networks, was introduced to evaluate the node trust based on the data. Practical reputation systems generally apply a centralized server to collect feedback for reputation generation (e.g., eBay, Yahoo auctions). However, many existing systems (e.g., Amazon and eBay) lack considerations on the credibility of user ratings. This greatly influences the quality of produced reputation. The usage of pseudonym and the ease of its change additionally complicate the picture by allowing participants to effectively erase their prior histories. A hybrid reputation system architecture, where reputation is evaluated in a distributed way, is provided, but with the support of a centralized trusted server. Sharing reputation information in the ad hoc networks introduce extra cost of communications. The purpose of reputation sharing is to make the reputation of a node known to all other nodes and decrease the detection time. Thus, maintaining and disseminating indirect reputation information incur overhead at both the individual node and the network. In the hybrid reputation system architecture concerning about both local and general reputations by aggregating local experiences and global experiences together, needs support of a centralized party.

However, none of the above studies can be directly applied into distributed network, especially PSN, since they cannot provide a decentralized trust evaluation and authentication scheme for distributed network or PSN. Even if they provide a system realizing a part of the functionality of decentralized trust evaluation and authentication, the trust evaluation is not transparent and traceable.

Third, privacy should be also considered in trust evaluation, which is hard to achieve in a decentralized manner.

Regarding trust evaluation in distributed network, especially PSN, there appear a number of studies on trust evaluation in recent years. A factor-enrichment-based hybrid trust framework for trust measurement in e-commerce on-line social networks is provided. In such hybrid trust framework, three levels of trust are used to establish trustworthy opinions among individuals for their transactions: 1) private reputation, subjective trustworthy impression among individuals with respect to its feature of dynamic evolution; 2) common reputation, collective and sharable trust degree and is proposed with two factors, a consistency factor and a continuity factor, introduced for enhancing the reliability of common reputation; and 3) the hybrid trust, which is proposed to obtain integrated trustable impressions based on private reputation and common reputation, with anti-fraud factor and confidence factor presented to further determine the trustworthiness of hybrid trust. Another example is a flow-based trust evaluation scheme named GFTrust. It uses network flow to model path dependence of trust and models trust decay with the leakage associate with each node, thus converts a trust evaluation task with path dependence and trust decay into a generalized network flow problem. There is also proposed a hierarchical evaluation system to support secure and trustworthy PSN with multiple and variable nodes. But the above works did not discuss how to implement the trust evaluation schemes in a purely decentralized manner.

In a trust-based privacy-preserving friend recommendation scheme for online social networks, various attributes are used to find matched friends and establish social relationships with strangers via a multi-hop trust chain, but how to apply this scheme into distributed network requires additional investigation. Inferring trust semantically from one mobile user to another that cannot be directly connected in the trust graph of MSNs by considering social context, context-aware trust model, and applying fuzzy linguistic technique, is provided. However, this solution mainly focuses on how to evaluate trust, but did not consider the evaluation process's transparency and trustworthiness. A new concept, Quality of Trust (QoT), considers such attributes as trust, social relationships and recommendation roles. This concept models an optimal social trust path selection problem with multiple end-to-end QoT constraints as a Multi-constrained Optimal Path (MCOP) selection problem and proposes an algorithm for the Optimal Social Trust Path selection. But this study did not discuss how to support decentralization and public auditing in the context of PSN.

Blockchain is firstly proposed by Nakamoto. It is a key technology to build the Bitcoin system. Recently, it has been paid wide attention by both academia and industry due to its advance for supporting decentralized functionalities. Blockchain originally is a continuously growing list of blocks, in which some information is recorded in series. It is a distributed ledger maintained by a number of parties together, without any dependence on a centralized party. Blocks are linked by using hash function. Typically, each block contains a hash pointer as a link to its previous block, a timestamp and information recorded in the block. In this way, any modification to previous blocks can be easily detected. Inspired by its application in Bitcoin, blockchain is being eagerly researched for providing decentralized secure solutions in Internet of things (IoT), cloud computing, data management, etc.

The consensus mechanism used in Bitcoin blockchain is based on Proof-of-Work, which is however not efficient and costs a lot of computational resources. The incentive mechanism in Bitcoin is the miner who makes a new block can win some Bitcoins.

Blockchain based applications are still in their infancy. For example, a new reputation system based on the blockchain raised recently can work in a P2P system, and hopefully any networking contexts. The created new blockchain stores data for reputation generation from completed transactions, e.g., file sharing. This system lacks proof on its generality. Linking with Bitcoin system implies its restriction on wide usage since it depends on Bitcoin system too much. Reputation calculation at a client is not beneficial for trust authentication in a transparent way. On the other hand, this system has a number of limitations with regard to scalability and efficiency, hard to be deployed in mobile devices. Therefore, there is no appropriate system for decentralized trust evaluation in distributed network, especially PSN.

In this disclosure, the applicant applies blockchain to build up a trustworthy distributed network environment, especially PSN environment, in a decentralized way. In this context, a plurality of nodes in the distributed network can perform social networking based on self-organized heterogeneous distributed networks. No any centralized servers are always available. Each node generates its own public and private key pair, which is used for distributed network. The blockchain is used to store the data related to trust evaluation and keep the record of node trust evolution.

In the blockchain, each block contains pervious block's ID, i.e., the hash value of the previous block, the underlying block's creation time, a list of trust values for each of the nodes for social networking, and pieces of information indicating evidence for trust evaluation based on which the trust values in the trust value list were derived, the evidence was derived after the previous block of the blockchain was created, a token issued to the creator of a previous block, as well as other essential data, such as revocation list of revoked public keys and updated public keys of the creator of the block. The methods for consensus and incentive and the block content structure in present disclosure are different from traditional bitcoin blockchain. The blockchain in present disclosure can be applied to achieve decentralized trust evaluation and trust authentication.

Regarding the consensus mechanism applied for block creation, a number of nodes that carrying out mining (i.e., miners) perform trust evaluation, by verifying and aggregating sufficient evidence collected after previous block is created, in order to derive, such as by calculating, related trust values of the nodes based on a pre-agreed common algorithm. In the context, the term of “miner” is only used to indicate the node(s) which creates new block of the blockchain in comparison to other nodes, rather than defining a different type of node.

Anode that creates a new block shares or announces the new block to other nodes. The new block will be determined as the next block if the mining work of the node for creating the new block can be approved by other nodes (referred to as approving node hereinafter), when the sum of trust values of the approving nodes is above a threshold and the total number of approving nodes is above an expected number. The design holds a principle that the sufficient number of reputable nodes decides the correctness of the blockchain.

This node that creates the new block can be awarded a token, which should be signed by all the approving nodes who approved the new block. The token can be used for specific social activities (e.g., advertisement) or gaining some benefits (e.g., coupon), which at least should be allowed by the nodes whose trust values are upgraded in the new block. Note that other usages or permissions can be granted to token holders.

In terms of the time to create a new block, it can define that when the size of all newly collected evidence reaches a threshold of an expected level, which can be verified by all nodes, the nodes can start creating the next block.

In embodiments of this disclosure, an algorithm can be applied to uniquely select the winner node in order to ensure decentralization of trust evaluation management and avoid blockchain fork. Concretely, one node cannot always win, and the total number of wins for an individual node in a specific time period can be limited based on the total number of nodes.

The current trust value of any node in the distributed network can be checked from any one of nodes that holds the latest blockchain. Thus, public verification of trust evaluation becomes open and transparent to every node in the distributed network for social networking. The public key can be revoked or updated, which is also recorded in the blockchain.

Trust evaluation can be context-aware. For supporting this feature, a context ID (e.g., expressed by a social application ID plus a social purpose ID) can be introduced into evidence and local trust value. Thus, the context ID is possible for the node to calculate trust values by linking them to concrete contexts. For example, if the user uses a messaging application for meeting, the context ID may be expressed by “messaging” as the application ID and by “meeting” as the purpose ID. In another case, if the user uses an online-banking application for paying, the context ID may be expressed by “online-banking” as the application ID and by “paying” as the purpose ID. Trust authentication can be performed by checking the historical records of trust values of a node based on its public key from the blockchain. Data access control based on trust values can also be implemented based on the open trust ledger recorded in the blockchain.

FIG. 1 shows an exemplary system model according to an embodiment of the present disclosure. The distributed network system 10 can comprise a plurality of nodes 101 that make use of heterogeneous distributed network 100 for social networking, especially pervasive social networking. The number of the nodes 101 can be N, where N is an integer that more than one. Some nodes 101 also behave as miners to maintain the blockchain that is used for trust evaluation and authentication in a decentralized way. Any node 101 can behave as a miner. Any node 101 can perform at least one of the functionalities of trust evaluation, block creating, winner node selection, etc. The miner can also perform the mining work only without any other functionality. In some embodiments, node 101 can be a server, terminal including fix terminal and mobile terminal, such as mobile phone, preferably smart phone, PDA, notebook, etc., interface, network device, and the like. Each node 101 contains a number of basic functional modules.

The security model of the system model 10 is that nodes 101 don't trust with each other, and they behave rationally and make decision based on the facts recorded in the blockchain. The most reputable nodes make decision together in order to achieve expected trust. It is assumed that each node can obtain synchronized time stamp (e.g., from public GPS signals) and it can generate its public-private key pair in aa secure way.

Table 1 summarizes the notations used in this disclosure.

TABLE 1
Notations and Definitions

| Notations | Definitions |
|---|---|
| Nᵢ | The node i |
| PKᵢ, SKᵢ | The public and private key pair of node i |
| SIG(m, SK) | The signing algorithm working on data m with |
| | private key SK; |
| H(·) | The hash function |
| Tₖ | The time stamp of Block k |
| Bₖ | The block k |
| B_IDₖ | The ID of block k |
| TV_{i,k} | The trust value of node i in block k |
| TO_{i′,k} | The token issued to node i′ for creating Bₖ₋₁, |
| | which appears in block k |
| TE_{i→j} | The evidence in terms of node i on node j |
| EV | The evidence threshold of evidence |
| CBₖ | The content of Bₖ |
| IN_{i→j} | The interaction number of communication |
| LTV_{i→j} | The local trust value of node i on node j |
| CV_{i→j} | The communication data volumes |
| F(·) | The evidence creation function |
| T_{TEi→j} | The time of evidence TE_{i→j} creation |
| Thr_{M} | The node threshold |
| Thr_{T} | The trust value threshold |
| ENC(m, DEK) | The signing algorithm working on data m with |
| | encryption key DEK |

Block Structure

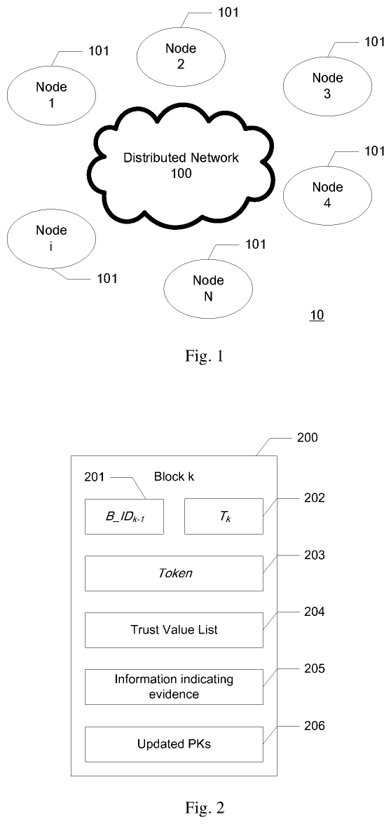

The structure of block k 200 of blockchain for trust evaluation and authentication according to an embodiment of present disclosure is designed and shown in FIG. 2. Block k 200 contains the ID 201 of the previous block of Block k 200, B_IDₖ, which is the hash vale of Block k−1 data CBₖ₋₁, i.e., B_IDₖ=H(CBₖ₋₁); the time stamp 202 of Block k 200, Tₖ, which is the time of creation of Block k 200; a token 203 issued to the miner i′ of Block k−1, TO_{i′,k-1}, which is signed by an expected number of nodes whose sum of trust values are above a trust value threshold of Thr_{T}, the item of token 203 can further comprises used tokens (the block ID of the used token) and profits specified for the token in the block; a trust value list 204 that records the trust value TV_{i,k} of nodes that have a newly updated trust value; evidence 205 that records of the evidence reported by the nodes after the previous block is created. The trust value list 204 can record the trust values of all nodes or a part of the nodes. The evidence 205 can also record all of the evidence reported by the nodes, or a part of the evidence reported. The evidence 205 can be ordered based on evidence on different nodes, such as identified by the public keys of the nodes. The evidence 205 can also be ordered based on other rules. For example, the rules may be the previous trust value of the nodes, or the tokens possessed by the nodes. In some embodiment, the evidence can be empty for some nodes in case that there are no any social interactions happened before the new block is created.

The trust value list 204 can be defined as the set of trust value of each node together with the public key of the node. For example, a trust value list can be denoted as {(TVⱼ, PKⱼ)}(j=1, . . . , J), where TV is the trust value of node j, PKⱼ is the public key of node j, and J is a positive integer representing the number of nodes in the distributed network. Therefore, the current trust value of each node can be extracted from the trust value list 204 of the current block of the blockchain if the current block of the blockchain is obtained.

Each of the nodes can derive new evidence after the current block of the blockchain was created and share the new evidence among the nodes. The nodes can derive the new evidence spontaneously or in response to the requests of other nodes that create a new block, i.e., the requests of miners. The new evidence, for example, can be derived from statistic communication information among the nodes, and the credibility of local trust value LTV_{i→j}. For example, the statistic communication information can comprise interaction number of communications among the nodes (i.e. IN_{i→j}) and the communication data volumes (i.e. CV_{i→j}). The statistic communication information can be collected from the network. The local trust value LTV_{i→j} can be the trust value provided by one node on other nodes from the node's own point of view. For example, the local trust value LTV_{i→j} of node Nᵢ on node N can be the trust value provided by node Nᵢ from the own point of view of node Nᵢ. The local trust value can also be provided or raised according to the point of view of node Nᵢ based on current information and the previous local trust value or trust value TV_{i→j} from the trust value list.

For saving the storage cost of the blockchain, the evidence 205 can be provided spontaneously or by requests of miners. The evidence 205 can also be saved in the blockchain or in another place (e.g., cloud or verified online database) in some embodiments. The system may save the content of evidence 205 in another place by its own or in response to the requests of users, for example. This evidence 205 may be a set of signatures on the interaction number of communication and the communication data volumes issued by nodes, which provide the fact of social communications among two nodes. This design can be applied for the purpose of fighting against malicious attacks on trust evaluation, e.g., bad-mouthing attack and unfair rating attack. Meanwhile, the evidence 205 does not disclose the details of social networking contents, but only statistics. The real identities of social networking parties are hidden, too, in order to preserve user privacies in the distributed network (e.g., PSN).

The public key pair of a node can be updated by a new key pair by announcing the following message to the miners: {PK,PKᵢ′,SIG((PKᵢ,PKᵢ′),SKᵢ)}. PK′ᵢ 206 is the new public key that replaces the old public key PKᵢ. If PKᵢ is null, it means PKᵢ is revoked by its owner.

Trust Evaluation

In the present disclosure, the evidence TE_{i→j} for trust evaluation is made by using IN_{i→j}, CV_{i→j} and the credibility of local trust value LTV_{i→j}. In an example, TE_{i→j} is obtained by the formula below:

TE_{i→j}=F(IN_{i→j},CV_{i→j},LTV_{i→j})=θ1(IN_{i→j})*θ2(CV_{i→j})*LTV_{i→j}

Herein, θ( ) is the Rayleigh cumulative distribution function.

$$θ ( g ) = \{ 1 - exp ( \frac{- {g}^{2}}{2 {σ}^{2}} ) \}$$

is applied to model the impact of number g, σ can be set as different values in θ1(x) and θ2(x) to scale the impact of IN_{i→j} and CV_{i→j} on TE_{i→j}, respectively. The evidence can be signed by its provider, for example, in a form of (TE_{i→j}, T_{TE}_{_{i→j}}, SIG(H (TE_{i→j}, TE_{TE}_{_{i→j}}), SKᵢ), where T_{TE}_{_{i→j}} is the time of generating the evidence TE_{i→j}. Thus, the evidence 205 in the block can be represented as {(TE_{i→j},T_{TE}_{_{i→j}},SIG(H(TE_{i→j},TE_{TE}_{_{i→j}}),SKᵢ)} (j=1, . . . , J; i=1, . . . , I), where I and J both are positive integers representing the number of nodes in the distributed network.

In order to overcome bad mouthing attack in trust evaluation, a deviation between the new evidence of node Nᵢ on node Nⱼ and the average of evidence of all nodes on node Nⱼ, as well as the previous trust value can be applied to tailor the contribution of individual evidence TE_{i→j} to the trust value calculation for creating a new block. The trust evaluation of each node Nᵢ, (i=1, . . . , I) on node Nⱼ, (j=1, . . . , J) can be performed by the miners during the process to create a new block based on the following formula:

$${TV}_{j , k} = \frac{1}{O} {\sum }_{i = 1}^{I} {TE}_{i \to j} * ( 1 - {dv}_{i , j} ) * {TV}_{i , {k}_{i}} * {e}^{- \frac{\vert k - {k}_{i} \vert}{τ}} , and$$

$${TV}_{j , k} = \frac{1}{( {e}^{\frac{\vert k - {k}_{i} \vert}{τ}} + 1 ) * O} {\sum }_{i = 1}^{I} {TE}_{i \to j} * ( 1 - {dv}_{i , j} ) + \frac{{e}^{\frac{\vert k - {k}_{i} \vert}{τ}}}{( {e}^{\frac{\vert k - {k}_{i} \vert}{τ}} + 1 )} {TV}_{i , {k}_{i}} * {e}^{- \frac{\vert k - {k}_{i} \vert}{τ}}$$

$$Where , {dv}_{i , j} = \vert {TE}_{i \to j} - \frac{1}{I} {\sum }_{i = 1}^{I} {TE}_{i \to j} \vert$$

is the deviation of the new evidence. I is the number of nodes which provide the new evidence to a miner Nⱼ.

$$O = {\sum }_{i = 1}^{I} ( 1 - {dv}_{i , j} ) .$$

Parameter τ is applied to control time decaying, so as to make the later trust value to contribute more in the trust evaluation. kᵢ is the block number of the latest TV_{i,k} appeared in the blockchain. (1−dv_{i,j}) is used to tailor TE_{i→j} so as to overcome the negative influence on the trust evaluation caused by bad mouthing attack or raised by malicious/distrusted evidence providing nodes.

In the first block of a blockchain, all nodes have no tokens, their trust values can be all 0, the evidence area is empty. It is assumed that the trust value can be a real number in the scope of [0, 1], where 0 represents fully distrust and 1 stands for fully trust. B_IDₖ₋₁ is empty in the first block.

The time to create a new block can be defined as: the volume of all collected evidence (e.g., size of all {TE_{i→j},T_{TE}_{_{i→j}},SIG(H(TE_{i→j},TE_{TE}_{_{i→j}}),SKᵢ)}) after the creation of previous block reaches an expected level. The expected level, for example, can be an evidence threshold (denoted as EV). Thus, the evidence that should be used for trust evaluation during the process of creating a new block can be verified by all miners. EV can be adjusted based on an agreement of miners.

The embodiment of present disclosure can be extended to support context-aware trust evaluation. The above evaluation information can be performed based on the social communication context, which can be indicated by a context ID (Cxt_ID) relative to the social communication context. The social communication context can be further specified by an application (indicated by App_ID) of the social communication and purpose (indicated by Pur_ID) of the social communication. In the blockchain, evidence and trust values are attached with a context ID, thus it is possible to perform context-aware trust evaluation and context-aware trust authentication. The examples for the context ID are introduced in the section of block structure above and will not discuss again.

In the block structure to support context-awareness, Trust value list={(TVⱼ,Cxt_ID,PKⱼ)}(j=1, . . . , J), and the record of evidence will be represented as {(TE_{i→j}, Cxt_ID, T_{TE}_{_{i→j}}, SIG(H(TE_{i→j},TE_{TE}_{_{i→j}}), SKᵢ) (j=1, . . . , J; i=1, . . . , I) respectively, in comparison to the block without context-awareness.

Consensus Mechanism

Herein, the embodiment of present disclosure does not use Proof-of-Work for consensus since it is not efficient and consumes a lot of computational resources. Trust evaluation is conducted by the miners by verifying and aggregating evidence to calculate related node trust values based on a predesigned algorithm. A node achieving the next block announces the next block to other nodes and this node can be awarded a token if its mining work can be approved by other nodes. These nodes can be referred as approving nodes, i.e., these nodes select the node achieving the next block as the winner node. The awarded token can be signed by a sufficient number of the nodes whose total sum of current trust values reaches a trust threshold. The sufficient number of the nodes can also mean that the number reaches a node threshold. The trust threshold is dynamically adjusted based on the status of blockchain, e.g., according to the total number of nodes and the trust values of nodes (refer to Algorithm 3 discussed below for details). The token can be used for social advertisement allowed by the nodes (e.g., whose trust values are upgraded in the new block). It is designed that the token issued to node i′ for its contribution of creating Block k−1 is as below:

TO_{i′,k}={B_IDₖ₋₁,PK_{i′},SIG(H(B_IDₖ₋₁,PK_{i′}),SK_{X},PK_{X}}

where SK_{X} is a series of private keys of all or part of the approving nodes, which are used to sign the token, and PK_{X} is a series of public keys of all or part of the approving nodes, which are used to sign the token. The token contains the underlying block's ID and the winner node's public key. It is signed by an expected number of other nodes, which is decided by the sum of nodes' reputation values, otherwise, the token is not valid. But this token appears in the next block k in order to prove the acceptance of previous block's creation and also to provide traceability on token issuing based on the advantage of blockchain. This design motivates the initial block's creation since the creator can gain a token that is applicable for all nodes (with initial trust value as 0). For token usage, it is very easy to know its applicability and correctness by checking with the blockchain.

Algorithm 1: Block k Creation

Algorithm 1 is designed to create a new block by evaluating trust values of nodes in the distributed network based on newly collected sufficient evidence. The verification on blockchain correctness also follows the same way in the process of Algorithm 1.

Each node can derive a new evidence since the current block of the blockchain was created and share the new evidence among the nodes. Such deriving and sharing can be done spontaneously or in response to the request of miners. The miner can receive the new evidence TE_{i→j}=F(IN_{i→j}, CV_{i→j}, LTV_{i→j}), (i=1, . . . , I; j=1, . . . , J), where I and J both are positive integers representing the number of nodes in the distributed network respectively, based on the collected statistic communication information among the nodes, i.e., IN_{i→j} and CV_{i→j}, and the credibility of local trust value LTV_{i→j} from the each node. The new evidence from the node is signed with the private key of the node deriving this new evidence.

If the size or volume of the collected evidence by the miner TE_{i→j} (i=1, . . . , I; j=1, . . . , J) reaches an evidence threshold EV, the miner can verify the correctness of all signatures on evidence. When the correctness is verified, the miner starts to calculate new trust values for each of the nodes based on the new evidence TE_{i→j}=F(IN_{i→j}, CV_{i→j}, LTV_{i→j}) collected.

In an embodiment of the present disclosure, the miner calculates the deviation dv_{i,j} between the new evidence and the average of the new evidence. Then the miner obtains the newest trust value TV_{i,k}_{ᵢ} in previous block(s) of the blockchain and calculate the trust value based on a following formula:

$${TV}_{j , k} = \frac{1}{O} {\sum }_{i = 1}^{I} {TE}_{i \to j} * ( 1 - {dv}_{i , j} ) * {TV}_{i , {k}_{i}} * {e}^{- \frac{\vert k - {k}_{i} \vert}{τ}}$$

In an embodiment, the miner can also check the correctness of all updated public keys by verifying corresponding signatures if the public key of the new block is updated.

The miner can insert the data of the new evidence into the content CBₖ of a new block Bₖ. Alternatively, the data of the new evidence can be stored outside the new block CBₖ, for example, in a cloud storage. The miner can insert a pointer for the data of the new evidence and a hash value of the data of the new evidence into the new block CBₖ, where the pointer refers to a location from where the data of the new evidence is available.

After the above calculations, the miner packages Bₖ based on block structure by calculating B_IDₖ₋₁, Tₖ and inserting the token TO_{i′,k} issued to block k−1 creator. It is noted that Tₖ is Bₖ's signing time by its creator.

Then, miner outputs and shares block k Bₖ, its public key as the creator's public key of the new block, and its signature with its public key on CBₖ as the creator's signature.

The pseudo code of an exemplary creation of block k is shown as following:

```
Input: TE_{i→j} = F(IN_{i→j},CV_{i→j},LTV_{i→j}),(i = 1,...,I; j = 1,...,J);
Bₗ(l = 1,...,k −1) , where I and J both are positive integers representing
the number of nodes in the distributed network;
When the size of all collected TE_{i→j}(i = 1,...,I; j = 1,...,J) reaches EV, do
  Verify the correctness of all signatures on evidence;
  For all i = 1,...,I; j = 1,...,J Do
    Collect TE_{i→j} = F(IN_{i→j},CV_{i→j},LTV_{i→j})
    Calculate dv_{i,j} based on TE_{i→j}
    Seek the newest TV_{i,k}_{ᵢ} in past blocks
    $Calculate {TV}_{j , k} = \frac{1}{O} {\sum }_{i = 1}^{I} {TE}_{i -> j} * ( 1 - {dv}_{i , j} ) * {TV}_{i , {k}_{i}} * {e}^{- \frac{\vert k - {k}_{i} \vert}{τ}}$
  Check the correctness of all updated public keys by verifying
  corresponding signatures;
  Package Bₖ based on block structure by calculating B_IDₖ₋₁ , Tₖ and
  inserting the token TO_{i′,k} issued to block k-1 creator;
Output: block k Bₖ , creator's public key, and the creator's signature on
CBₖ .
```

It should be understood that other algorithms for calculating the trust value based on the collected evidence can be applied in the embodiment of present disclosure. The above exemplary algorithm is only an exemplary approach.

Algorithm 2: Mining Winner Selection

In case that multiple miners work out the new block, the present disclosure apples Algorithm 2 to select the winner node, i.e., the winner among the miners that create a new block respectively, in order to avoid blockchain fork. The new block created by the winner node is taken as an approved new block.

In an embodiment, the winner node can be selected based on the creating time at which the nodes create the new blocks, the number of tokens possessed by the node, the trust values of the nodes, the number of node trust values which the node has calculated, the public keys of the nodes, or any of the combinations of above conditions.

In an embodiment, the winner node can be selected based on the creating time at which the node creates the new block. For example, the node that creates the new block at the earliest time wins. Applying this rule aims to ensure the efficiency of blockchain creation. In an embodiment, the node that creates the new block at the latest time can also be considered as winner. But if a node holds too many tokens, the system gives priority to another node so as to ensure decentralization and avoid such a situation that the blockchain is controlled by few nodes. Therefore, the winner node can be selected based on the number of token which the node that creates the new block has. In an embodiment, in case that at least two nodes create the block simultaneously, the system gives the node with highest social trust value a higher priority, since the node holding a highest trust value has more incentive to behave honestly for block creation. Therefore, the winner node can be selected based on the trust value of the node that creates the new block. But if the reputable node holds too many tokens, the system can avoid giving priority to this node again. For example, the system can give priority to another node, so as to ensure decentralization and avoid such a situation that the blockchain is controlled by few nodes. In an embodiment, the node with highest social trust value can have a higher priority.

In an embodiment, in case that at least two nodes create the blocks at the same time and have the same trust values, the system gives a higher priority to the node with less number of tokens. This rule aims to avoid the situation that the blocks are generated by a small number of miners in order to ensure decentralization. In case that two nodes create the blocks have same number of tokens at this moment, the system lets the miner that calculates less node trust values in the past win. It is noted that “in the past” can mean the duration since the previous block was created, or since one of some of the previous blocks was created, since the first block of the blockchain was created, or since a specific time point which is selected by user or system. Therefore, the winner node can be selected based on the number of node trust values which the node has calculated in the past. Applying this rule is for balancing computation contributions in the whole system, which is another strategy to ensure decentralization. In case that two nodes create the new blocks have same numbers of node trust values which the node has calculated in the past again in the above process (i.e., the same numbers of trust values are calculated by two miners Nᵢ, and Nⱼ), the node with a bigger (or smaller) public key wins. Therefore, the winner node can be selected based on the public key of the node that creates the new block. The possibility that two miners have same public keys is very small.

In case that multiple miners create the new block at the same time, the system selects a winner by following the similar rules as above. The node that makes the selection of winner node can sign the selection result with its private key and share the selection result.

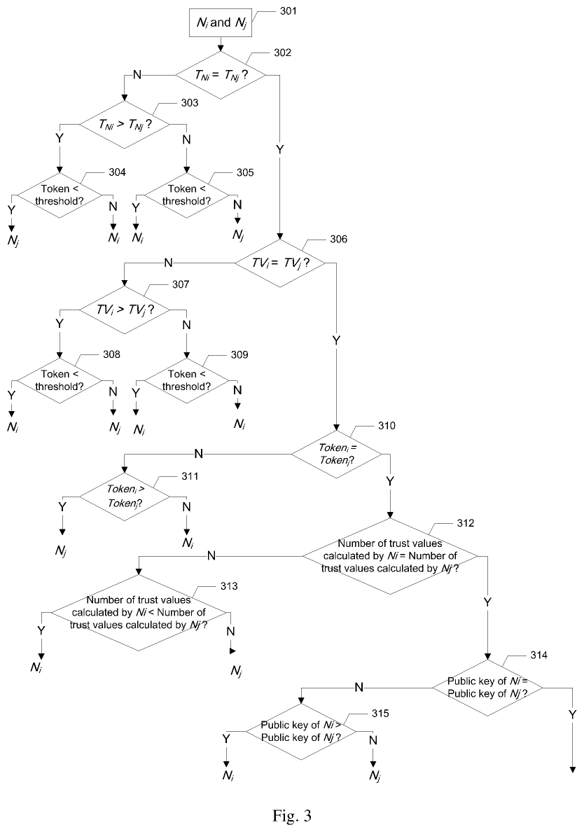

FIG. 3 shows an exemplary embodiment for winner node selection from nodes Nᵢ and Nⱼ.

First, at step 301, the approving node obtains two new blocks created by two nodes Nᵢ and Nⱼ. Then at step 302, the approving node determines whether the creating times T_{Ni} and T_{Nj} of these nodes Nᵢ and Nⱼ, respectively, are the same. If their creating times are not same, the method proceeds to step 303. If T_{Ni} is bigger than T_{Nj}, which means that node N creates the new block earlier than node Nᵢ, the method proceeds to step 304, otherwise the method proceeds to step 305. In step 304, the number of tokens possessed by the node are further compared to a token threshold. If the number of the tokens possessed by node Nⱼ does not exceeds the token threshold, the winner node is node Nⱼ, otherwise the winner node is node Nᵢ. Step 305 applies same logical determination as step 304. In step 305, if the number of tokens possessed by node Nᵢ does not exceeds the token threshold, the winner node is node Nᵢ, otherwise node Nⱼ.

If the creating times of these two nodes are the same in step 302, the method proceeds to step 306 for comparing the current trust value of the nodes. If the current trust values are not same, the method proceeds to step 307. If the trust value of node Nᵢ, i.e., TVᵢ, is bigger than the current trust value of node Nⱼ, i.e., T_{Vj}, the method proceeds to step 308 to continue compare the number of tokens possessed by them, otherwise the method proceeds to step 309. If the number of the tokens possessed by node Nᵢ does not exceeds the token threshold, the winner node is node Nᵢ, otherwise the winner node is node Nⱼ. Step 309 applies same logical determination as step 308. In step 309, if the number of tokens possessed by node Nⱼ does not exceeds the token threshold, the winner node is node Nⱼ, otherwise node Nᵢ.

If the current trust values of the two nodes are the same in step 306, the method proceeds to step 310 to further compare the number of tokens which they possess. If the numbers of tokens possessed by these nodes are not the same, the method proceeds to step 311. In step 311, if the number of tokens possessed by node Nᵢ is bigger than node Nⱼ, the winner node is node Nⱼ, which means that the node with smaller number of tokens already will win, otherwise the winner node is node Nᵢ.

If the numbers of the tokens possessed by the two nodes are the same in step 310, the method proceeds to step 312 to continue compare the number of trust values calculated by two nodes. If the numbers of trust values calculated by two nodes are not the same, the method proceeds to step 313. In step 313, the node with the smaller number of trust values calculated wins.

In step 312, if the numbers of trust values calculated by two nodes are the same, the method proceeds to step 314 to further compare their public keys. If their public keys are not the same, the method proceeds to step 315. In step 315, the node with bigger public key will win. The possibility that two nodes have same public keys is very small, so that the case that the public keys of nodes Nᵢ and Nⱼ are the same will not be considered.

Note that, in order to ensure decentralization, one miner cannot always win, the system can limit the total number of wins for an individual miner in a specific time period based on the total number of nodes. For example, in a specific time period, a miner cannot win more than M tokens, where M is the total number of registered nodes). Algorithm 2 ensures that only one winner of a new block creation can be found, thus no blockchain fork could happen. Any mistake on block creation can be found and solved.

Algorithm 3: Consensus Policy and Threshold Setting

In order to make a consensus, it is needed to set up a good decision-making solution, which should adapt to the system situation. In embodiments, a node threshold Thr_{M} and a trust value threshold Thr_{T} are automatically set based on the trust values of all registered nodes and the number of nodes. The system policy can be that the higher the sum of trust values of the nodes selecting (i.e., approving the miner) the miner as the winner node on new block creation, the lower number of these nodes selecting the miner as the winner node needed. The system can further set Thr_{T} in order to ensure that the total sum of the trust values of nodes selecting the miner as the winner node should be above an expected level, for example,

$${Thr}_{T} = \frac{{Thr}_{M}}{M} {\sum }_{m = 1}^{M} {TV}_{m} .$$

This design aims to improve the efficiency of consensus and enhance the trustworthiness of block creation since the system tries to ensure that the new block creation should be approved by sufficient number of nodes with sufficient reputation. At the initial time of blockchain creation, all trust values of the nodes are 0, thus the second block creation should be approved by all nodes.

The following shows the pseudo code of an exemplary algorithm 3 for calculating the thresholds Thr_{M} and Thr_{T}, where

$$⌊ M * ( 1 - \frac{1}{M} {\sum }_{m = 1}^{M} {TV}_{m} ) ⌋$$

means that the result is the biggest positive integer which is no bigger than

$$M * ( 1 - \frac{1}{M} {\sum }_{m = 1}^{M} {TV}_{m} ) .$$

Input: TVₘ : trust value of miner Nₘ ; M: the total number of nodes.
Set
${Thr}_{M} = ⌊ M * ( 1 – \frac{1}{M} {\sum }_{m = 1}^{M} {TV}_{m} ) ⌋ \text{+} 1 ; if {Thr}_{M} \geq M , set {Thr}_{M} = M –1 .$
$\begin{matrix}Where ⌊ M * ( 1 - \frac{1}{M} {\sum }_{m = 1}^{M} {TV}_{m} ) ⌋ = max \{ n \} , ( n ∈ Z , n \leq M * \\ ( 1 – \frac{1}{M} {\sum }_{m = 1}^{M} {TV}_{m} ) ) ) , Z is a set of positive integers .\end{matrix}$
${Thr}_{T} = \frac{{Thr}_{M}}{M} {\sum }_{m = 1}^{M} {TV}_{m} .$
Output: Thr_{M} and Thr_{T} .

Incentive Mechanism

A token is issued and granted for successfully creating a new block. The token can be used for specific social activities (e.g., advertisement) or gaining some benefits (e.g., coupon), at least allowed by the nodes whose trust values are upgraded in the new block. Note that other usages or permissions can be granted to token holders.

Taking a concrete example of an incentive mechanism, the token can be used for advertising in the distributed network, especially PSN. With tokens, advertisement cannot be treated as SPAM and should not be feedback a negative local trust value on it, at least by the nodes whose trust values are upgraded in the corresponding block. Sending a conflict local trust for such an advertisement is treated invalid. Thus, this kind of negative evidence on node trust will not be counted in node trust evaluation. The system uses this incentive mechanism to encourage miners to work for maintaining the blockchain since permission on advertisement can help nodes earn extra profits. Note that token usage information can be also recorded in the blockchain in order to overcome real spam. The token holder can only use its token to do specified things or claim specified profits.

Trust Authentication and Trust Value Based Data Access Control

The blockchain designed in the embodiment of present disclosure serves as an open ledger to record trust information, such as trust value. By accessing the blockchain, each node can get all trust information of the nodes with its evolutionary history and can verify if the current and past trust values were evaluated correctly. Thus, the system provides an open and transparent way for trust authentication.

For example, when node Nⱼ wants to control its communication data access, it can encrypt its message with key DEKⱼ, and issue the DEKⱼ to the nodes whose trust values are satisfied with its access policy by checking the blockchain. Concretely, DEKⱼ is encrypted with PKᵢ, where the trust values of the holders of PKᵢ are consistent with access policy of node Nⱼ. The communication package with message mi delivered by Nⱼ is {ECN(mⱼ,DEKⱼ),ENC(DEKⱼ,PKᵢ)}, thus only the node with PKᵢ whose trust value satisfied with the access policy can access mⱼ. The encryption algorithm can be an Attribute-Based Encryption algorithm (ABE), an Identity-Based Encryption algorithm (IBE), or an Identity-Based Encryption and Signature algorithm (IBES), a Public Key Encryption algorithm, or a Homomorphic Encryption algorithm, for example, or other encryption schemes.

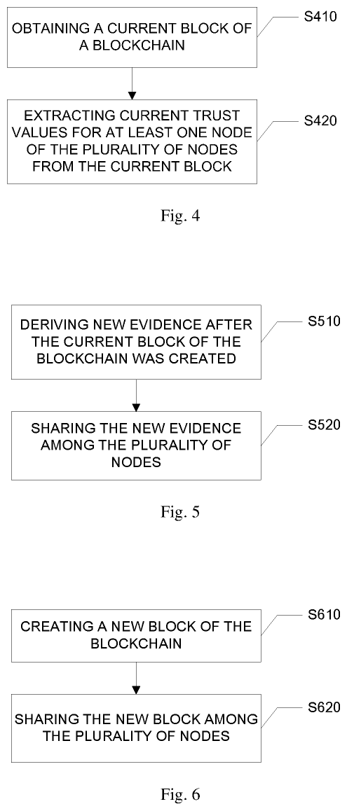

FIG. 4 shows an exemplary method for decentralized trust evaluation in a distributed network according to the embodiment of present disclosure, comprising the steps of:

S410: obtaining a current block of a blockchain; and

S420: extracting current trust values for at least one node of the plurality of nodes from the current block.

The current block of the blockchain comprises the hash value of the previous block of the blockchain, a timestamp of creation of the current block, a token issued to a node that creates the previous block of the blockchain, a trust value list indicating current trust values for each of the plurality of nodes, and information indicating evidence based on which the trust values in the trust value list were derived, the evidence was derived after the previous block of the blockchain was created.

FIG. 5 is an exemplary method for decentralized trust evaluation in a distributed network according to the embodiment of present disclosure, especially collecting the new evidence, comprising the steps of:

S510: deriving a new evidence after the current block of the blockchain was created; and

S520: sharing the new evidence among the plurality of nodes.

Deriving the new evidence can comprise collecting statistic communication information among the plurality of nodes; and deriving the new evidence based on the statistic communication information among the plurality of nodes and on local trust values on the other nodes of the plurality of nodes. In an embodiment, the statistic communication information comprises interaction number and communication data volumes among the plurality of nodes. The method also comprises signing the new evidence with the private key of the node that shares the new evidence.

In FIG. 6, an exemplary method for decentralized trust evaluation in a distributed network according to the embodiment of present disclosure, especially creating a new block of the blockchain, is illustrated. The method comprises the steps of:

S610: creating a new block of the blockchain; and

S620: sharing the new block among the plurality of nodes.

S610 can further comprises collecting new evidence, wherein the new evidence was derived after the current block was created; and calculating new trust values for each of the plurality of nodes based on the new evidence. The calculation for trust value can be performed in case that the size of the evidence reaches an evidence threshold.

In an embodiment, the calculation for trust values can comprise calculating new trust values for each of the plurality of nodes based on the deviation between the new evidence and an average of the new evidence, and the current trust values for each of the plurality of nodes. The method can also comprise the steps of verifying, such as verifying the correctness of the new evidence. The node that creates the new block can also insert its public key into the new block and/or sign the new block with the private key of the node that creates the new block.

Regarding the data of the evidence, it can be inserted into the new block, or be stored outside the new block, such as being stored in a cloud storage, where a pointer for the data of the new evidence and a hash value of the data of the new evidence is inserted into the new block, the pointer referring to a location from where the data of the new evidence is available.

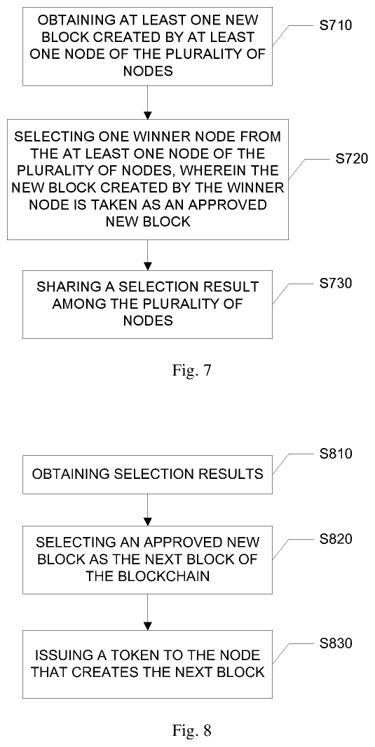

FIG. 7 shows an exemplary method for decentralized trust evaluation in a distributed network according to the embodiment of present disclosure, especially selecting an approved new block. The method comprises the steps of:

S710: obtaining at least one new block created by at least one node of the plurality of nodes;

S720: selecting one winner node from the at least one node of the plurality of nodes, wherein the new block created by the winner node is taken as an approved new block; and

S730: sharing a selection result among the plurality of nodes.

The selection can be done based on the creating time at which the node creates the new block, the number of tokens possessed by the node, the trust values of the nodes, the number of node trust values which the node has calculated, the public keys of the nodes, and any combination of above strategies. For example, the selection can be done based on the strategy as shown in FIG. 3. The node which makes the selection can also sign its selection result with its private key.

FIG. 8 shows an exemplary method for decentralized trust evaluation in a distributed network according to the embodiment of present disclosure, especially issuing a token to the winner node. The method comprises the steps of:

Step 810: obtaining selection results;

Step 820: selecting an approved new block as the next block of the blockchain; and

Step 830: issuing a token to the node that creates the next block.

The winner node of the new block, for example, can be determined if the sum of the current trust values of the nodes which select the node that creates the next block as the winner node reaches a trust value threshold, which is relative to the current trust values of each node and the number of the plurality of the nodes, or if the number of the nodes which select the node that creates the next block as the winner node reaches a node threshold, which is relative to the current trust values of each node and the number of the plurality of the nodes.

In an embodiment, the token issued can be generated based on the hash value of the current block of the blockchain, the public key of the node that creates the next block, the signatures with the private keys of the nodes that select the node that creates the next block as the winner node, and the public keys of the nodes that select the node that creates the next block as the winner node.

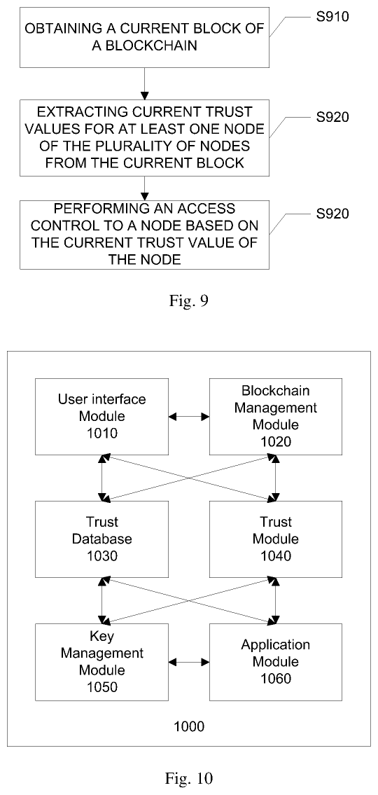

FIG. 9 is an exemplary method for decentralized trust evaluation in a distributed network according to the embodiment of present disclosure, especially performing an access control. The method comprises the steps of:

Step 910: Obtaining a current block of a blockchain;

Step 920: Extracting current trust values for at least one node of the plurality of nodes from the current block; and

Step 930: performing an access control to a node based on the current trust value of the node.

In specific, the node performing the access control can allow an access right to a node whose current trust value meets an access strategy, and further encrypt the information to be accessed by an allowed node with the private key of the allowed node based on an Attribute-Based Encryption algorithm, a Public Key Encryption algorithm, or a Homomorphic Encryption algorithm.

In some embodiments of present disclosure, the evidence and the trust value are relative to a context information relative to application of social communication and purpose of social communication.

The embodiment of present disclosure also provides an apparatus 1000 for decentralized trust evaluation in a distributed network as shown in FIG. 10, wherein the distributed network comprises a plurality of nodes.

The apparatus 1000 can comprise User Interface module 1010, Blockchain Management module 1020, Trust Database 1030, Trust module 1040, Key Management module 1050, Application module 1060, and other necessary modules which are not shown. Each of the modules communicates with each other in data and/or command.

In the exemplary structure shown in FIG. 10, the apparatus 1000 can be node i 101 in FIG. 1.

The User Interface module 1010 is applied to display the contents of blockchain and show blockchain information. For example, the User Interface module 1010 can be a visualization user interface (UI) for displaying the content of the block of the blockchain. The User Interface 1010 can also be capable of extracting the content from the block. In some embodiments, the User Interface module 1010 can be a display with input device, such as keypad, pointing device, touch screen, etc.

Blockchain Management module 1020 can be responsible for performing the tasks that should be done by a miner if the underlying node wants to be a miner. Blockchain Management module 1020 can further be responsible for performing the tasks that should be done if the node wants to select a node as a winner node that creates the approved block of the blockchain. Blockchain Management module 1020 can further be responsible for performing the task that should be done that the node 101 in FIG. 1 wants to generate the evidence and share among all of the nodes 101. Blockchain Management module 1020 can further be responsible for performing the task that should be done that the node 101 wants to perform access control based on the trust value with other nodes 101.

Trust module 1040 can be applied to collect and record statistic communication information, such as social networking data statistics. The Trust module 1040 can further be applied to handle communications between the node i 101 and other nodes 101 in FIG. 1. Trust module 1040 can further be applied to share information among the nodes 101. In an embodiment, Trust module 1040 can further be applied to report local trust value and evidence to miners in FIG. 1.

Key Management module 1050 can be used for any one of generating a personal key pair, responsible for hashing data, checking data integrity, signing/verifying signatures, inserting personal keys into the block, and other events relative to security.

Application module 1060 can be used to carry out some applications for distributed social networking, especially PSN, or it can be used for performing different kinds of social networking for different social purposes. In some embodiments, App_ID is used to represent the kind of social networking and Pur_ID is used to represent the social purpose, respectively.

All information related to the above functional modules of apparatus 1000, e.g., latest content of the block of blockchain if node needs to keep a copy locally, local records of distributed network, public-private key pair, etc., can be stored at Trust DataBase 1030.

It is assumed that the Trust DataBase 1030 can be well protected and safe. Non-authorized parties cannot access it. In case of the limitation of local storage, some contents can be stored in another place, e.g., cloud with essential protection like encryption. A link directing to the remotely stored contents, such as a pointer, can be kept locally. A suitable miner could be some edge devices that have sufficient computation and storage resources.

These listed modules are not all necessary for some functions. For example, the apparatus 1000 for obtaining the trust values of at least one node can comprise at least trust module 1040, and user interface module 1010. The apparatus 1000 for deriving a new evidence, or for creating a new block of the blockchain, or for selecting a winner node, or for issuing token, or for access control, can comprise at least trust module 1040, user interface module 1010, and blockchain management module 1020. The apparatus 1000 can comprise other combination of these modules according to the requirements of the functions.

The trust module 1030 can be configured to obtain a current block of a blockchain, and the User Interface module 1010 can be configured to extract current trust values for at least one node of the plurality of nodes from the current block and show blockchain information.

For example, in the functionality of collecting a new evidence, the Blockchain Management module 1020 can be configured to derive a new evidence after the current block of the blockchain was created; and the Trust module 1040 can be further configured to share the new evidence among the plurality of nodes. The Trust module 1040 can collect statistic communication information among the plurality of nodes, and the Blockchain Management module 1030 can derive the new evidence based on the statistic communication information among the plurality of nodes and on local trust values on the other nodes of the plurality of nodes. The Key Management module 1050 can sign the new evidence with the private key of the node that shares the new evidence.

In an embodiment for new block creation, the Blockchain Management module 1020 can further create a new block of the blockchain; and the Trust module 1040 can share the new block among the plurality of nodes. In specific, the Trust module 1040 can collect new evidence; and the Blockchain Management module 1020 can further calculate new trust values for each of the plurality of nodes based on the new evidence, preferably in case that the size of the evidence reaches an evidence threshold. For example, the Blockchain Management module 1020 can calculate new trust values for each of the plurality of nodes based on the deviation between the new evidence and an average of the new evidence, and the current trust values for each of the plurality of nodes. Also, the Key Management module 1050 can verify the correctness of the new evidence, insert a public key of the node that creates the new block into the new block, or sign the new block with the private key of the node that creates the new block.

Regarding to the data of the new evidence, the Blockchain Management module 1020 can insert the data of the new evidence into the new block or insert a pointer for the data of the new evidence and a hash value of the data of the new evidence. The pointer can refer to a location from where the data of the new evidence is available, and the data of the new evidence can be stored outside the new block, such as in a cloud storage.

In an embodiment for selecting an approved new block, the Trust module 1040 can further obtain at least one new block created by at least one node of the plurality of nodes and the Blockchain Management module 1020 can select one from the at least one winner node from the at least one node of the plurality of nodes, wherein the new block created by the winner node is taken as an approved new block, such that the Trust module 1040 can share a selection result among the plurality of nodes. The selection for winner node can be done based on the creating time at which the nodes create the new blocks, the number of tokens possessed by the node, the trust values of the nodes, the number of node trust values which the node has calculated, the public keys of the nodes, and any combination of above strategies. For example, the selection can be done based on the strategy as shown in FIG. 3. The Key Management module 1050 can also sign the selection result with the private key of the node that shares the selection result.

Regarding the process of issuing a token, the Trust module 1040 can be further configured to obtain selection results, and the Blockchain Management module 1020 can select an approved new block as the next block of the blockchain and issue a token to the node that creates the next block. If the sum of the current trust values of the nodes which select the node that creates the next block as the winner node reaches a trust value threshold and/or the number of the nodes which select the node that creates the next block as the winner node reaches a node threshold, the Blockchain Management module 1020 can select an approved new block as the next block of the blockchain. The Blockchain Management module 1020 can also generate the token issued to the node that creates the next block based on the hash value of the current block of the blockchain, the public key of the node that creates the next block, the signatures with the private keys of the nodes that select the node that creates the next block as the winner node, and the public keys of the nodes that select the node that creates the next block as the winner node.

In an embodiment of performing access control, the Trust module 1040 can allow an access right to a node whose current trust value meets an access strategy. For example, the Key Management module can be configured to encrypt the information to be accessed by an allowed node with the private key of the allowed node based on an Attribute-Based Encryption algorithm, a Public Key Encryption algorithm, or a Homomorphic Encryption algorithm.

In some embodiments of present disclosure, Application module 1060 can provide a context information relative to the application of social communication and the purpose of social communication. The evidence and the trust value can be relative to the context information.

The Trust Database 1030 can store data of the current block of the blockchain.

Since the system, method, and apparatus for decentralized trust evaluation in a distributed network, especially PSN, is based trust evaluation and authentication, they can overcome the traditional problems of Bitcoin blockchain in terms of efficiency, decentralization assurance and blockchain fork issue. It provides motivation for creating a new block by a miner without setting any computation difficulties. Algorithm 2 can decide and easily verify a unique block creator, thus avoid blockchain fork is considered. In addition, it considers how to ensure decentralization in the design of Algorithm 2. For enhancing efficiency, Algorithm 3 is designed to pursue consensus with sufficient reputation and sufficient number of approvers on a new block creation, and at the same time pay attention to efficiency.

Regarding to security, trust evidence with its credibility, evidence deviation and past trust value is applied in the design of trust evaluation in order to overcome attacks on trust evaluation, e.g., bad mouthing attack and unfair rating attack. The system's security also highly depends on the security theory applied by blockchain itself by benefiting from its advantages.

About Sybil attack, some nodes could regenerate a new key pair in order to remove past bad social history or holds a number of key pairs to launch some attacks. In order to overcome this problem, the system makes initial trust value of new node as lowest as zero and let trust value attaches to distributed network behaviors and facts. Thus, it is not worth using a new key pair to restart. Past trust value is considered with time decaying in the new trust value evaluation. Meanwhile, context-aware trust evaluation can be supported. Thus, it is not necessary for a node to use multiple key pairs.

Privacy can be enhanced based on the following mechanisms: 1) The key pair does not link to any personal information or personal identity of a node or a user; 2) The social communication and social behavior evidence is hashed and signed, social interaction details are not disclosed. The only disclosed information is some statistics: social communication interaction times and communication data volume.

For example, this application can be applied into mobile device business and products for future generation mobile and wireless communication systems since blockchain based solutions are becoming very popular in IoT, banking, health services and data management. Some investigation has been given to support producing blockchain-enabled mobile devices.

FIG. 11 illustrates a computer system 1100 upon which an embodiment of the disclosure can be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is designed and is programmed (e.g., via computer program code or instructions) for decentralized trust evaluation in a distributed network as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. Computer system 1100, or a portion thereof, constitutes a means for performing one or more steps of security and trust technologies and solutions in virtualized networks.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to the decentralized trust evaluation in a distributed network as described herein. The computer program code is a set of instructions or statements providing instructions for the operation of the processor and/or the computer system to perform specified functions. The code, for example, can be written in a computer programming language that is compiled into a native instruction set of the processor. The code can also be written directly using the native instruction set (e.g., a machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors can be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for decentralized trust evaluation in a distributed network as described herein. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for decentralized trust evaluation in a distributed network as described herein, is provided to the bus 710 for use by the processor from an external input device 1112, such as a keyboard containing alphanumeric keys operated by a human user, or a sensor. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general, the coupling is with a network link that is connected to a local network to which a variety of external devices with their own processors are connected. For example, communication interface 1170 can be a parallel port or a serial port or a universal serial bus (USB) port on a personal computer. In some embodiments, communications interface 1170 is an integrated service digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 can be a local area network (LAN) card to provide a data communication connection to a compatible LAN, such as Ethernet. Wireless links can also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communication interface 1170 includes a radio band electromagnetic transmitter and receiver called a radio transceiver. In certain embodiments, the communication interface 1170 enables connection to virtualized networks for decentralized trust evaluation in a distributed network as described herein.

The term “computer-readable medium” as used herein refers to any medium that participates in providing information to processor 1102, including instructions for execution. Such a medium can take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

At least some embodiments of the disclosure are related to the use of computer system 71100 for implementing some or all of the techniques described herein. According to one embodiment of the disclosure, those techniques are performed by computer system 1100 in response to processor 1102 executing one or more sequences of one or more processor instructions contained in memory 1104. Such instructions, also called computer instructions, software and program code, can be read into memory 1104 from another computer-readable medium such as storage device 1108 or network link. Execution of the sequences of instructions contained in memory 1104 causes processor 1102 to perform one or more of the method steps described herein. In alternative embodiments, hardware, such as ASIC 1120, can be used in place of or in combination with software to implement the invention. Thus, embodiments of the invention are not limited to any specific combination of hardware and software, unless otherwise explicitly stated herein.

The signals transmitted over network link and other networks through communications interface 1170, carry information to and from computer system 1100. Computer system 1100 can send and receive information, including program code, through the networks, through communications interface 1170. The received code can be executed by processor 1102 as it is received, or can be stored in memory 1104 or in storage device 1108 or other non-volatile storage for later execution, or both. In this manner, computer system 1100 can obtain application program code in the form of signals on a carrier wave.

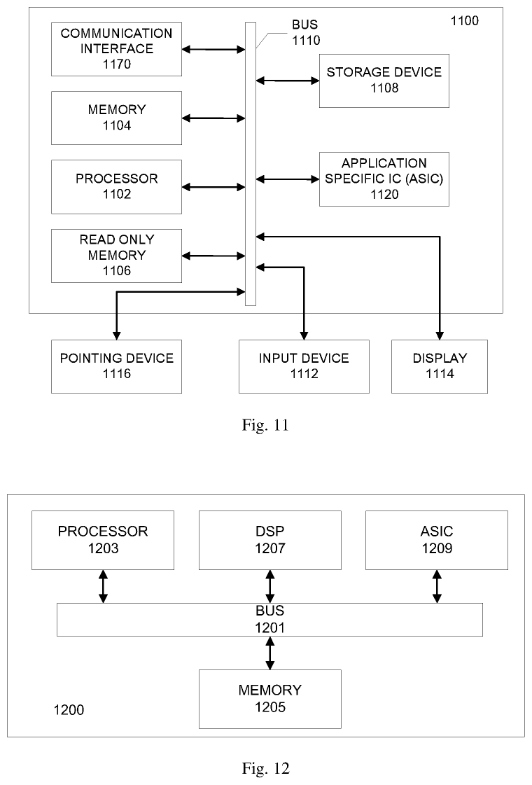

FIG. 12 illustrates a chip set 1200 upon which an embodiment of the disclosure can be implemented. Chip set 1200 is programmed to decentralized trust evaluation in a distributed network as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1200, or a portion thereof, constitutes a means for performing one or more steps of performing multiple forms of communication in the same communication session.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 can include one or more processing cores with each core configured to perform independently. A multi-core processor enables multiprocessing within a single physical package. Examples of a multi-core processor include two, four, eight, or greater numbers of processing cores. Alternatively, or in addition, the processor 803 can include one or more microprocessors configured in tandem via the bus 801 to enable independent execution of instructions, pipelining, and multithreading. The processor 1203 can also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to perform multiple forms of communication in the same communication session. The memory 1205 also stores the data associated with or generated by the execution of the inventive steps.

The present disclosure includes any novel feature or combination of features disclosed herein either explicitly or any generalization thereof. Various modifications and adaptations to the foregoing exemplary embodiments of this disclosure can become apparent to those skilled in the relevant arts in view of the foregoing description, when read in conjunction with the accompanying drawings. However, any and all modifications will still fall within the scope of the non-limiting and exemplary embodiments of this invention.

1-90. (canceled)

91. An apparatus comprising
at least one processing core,
at least one memory including computer program code,
the at least one memory and the computer program code being configured to, with the at least one processing core, cause the apparatus at least to:
obtain a current block of a blockchain, wherein the current block of the blockchain comprises the hash value of the previous block of the blockchain, a timestamp of creation of the current block, a token issued to a node that creates the previous block of the blockchain, a trust value list indicating current trust values for each of the plurality of nodes, and information indicating evidence based on which the trust values in the trust value list were derived, the evidence was derived after the previous block of the blockchain was created; and
extract current trust values for at least one node of the plurality of nodes from the current block and show blockchain information.

92. The apparatus according to claim 91, is further caused to:
derive a new evidence after the current block of the blockchain was created; and
share the new evidence among the plurality of nodes.

93. The apparatus according to claim 92, is further caused to:
collect statistic communication information among the plurality of nodes; and
derive the new evidence based on the statistic communication information among the plurality of nodes and on local trust values on the other nodes of the plurality of nodes.

94. The apparatus according to claim 93, wherein the statistic communication information comprises interaction number and communication data volumes among the plurality of nodes.

95. The apparatus according to claim 92, is further caused to:
sign the new evidence with the private key of the node that shares the new evidence.

96. The apparatus according to claim 91, is further caused to:
create a new block of the blockchain; and
share the new block among the plurality of nodes.

97. The apparatus according to claim 96, is further caused to:
collect new evidence, wherein the new evidence was derived after the current block was created; and
calculate new trust values for each of the plurality of nodes based on the new evidence.

98. The apparatus according to claim 97, is further caused to:
calculate the new trust values for each of the plurality of nodes based on the new evidence, in case that the size of the evidence reaches an evidence threshold; or
calculate the new trust values for each of the plurality of nodes based on the deviation between the new evidence and an average of the new evidence, and the current trust values for each of the plurality of nodes.

99. The apparatus according to claim 97, is further caused to verify the correctness of the new evidence.

100. The apparatus according to claim 97, is further caused to insert a public key of the node that creates the new block into the new block.

101. The apparatus according to claim 97, is further caused to insert the data of the new evidence into the new block.

102. The apparatus according to claim 97, is further caused to insert a pointer for the data of the new evidence and a hash value of the data of the new evidence, wherein the pointer refers to a location from where the data of the new evidence is available, and the data of the new evidence is stored outside the new block.

103. The apparatus according to claim 102, wherein the data of the new evidence is stored in a cloud storage.

104. The apparatus according to claim 97, is further caused to sign the new block with the private key of the node that creates the new block.

105. The apparatus according to claim 91, is further caused to:
obtain at least one new block created by at least one node of the plurality of nodes;
select one winner node from the at least one node of the plurality of nodes, wherein the new block created by the winner node is taken as an approved new block; and
share a selection result among the plurality of nodes.

106. The apparatus according to claim 105, is further caused to select the winner node based on at least one of the following:
the creating time at which the nodes create the new blocks;
the number of tokens possessed by the node;
the trust values of the nodes;
the number of node trust values which the node has calculated;
the public keys of the nodes;
or the node that creates the new block at earliest time, except that the number of tokens possessed by the node goes beyond a token threshold.

107. The apparatus according to claim 91, the apparatus is further caused to:
obtain selection results;
select an approved new block as the next block of the blockchain, and issue a token to the node that creates the next block.

108. The apparatus according to claim 107, is further caused to select an approved new block as the next block of the blockchain, in case that the sum of the current trust values of the nodes which select the node that creates the next block as the winner node reaches a trust value threshold.

109. A method for decentralized trust evaluation in a distributed network, the distributed network comprising a plurality of nodes, the method comprising:
obtaining a current block of a blockchain, wherein the current block of the blockchain comprises the hash value of the previous block of the blockchain, a timestamp of creation of the current block, a token issued to a node that creates the previous block of the blockchain, a trust value list indicating current trust values for each of the plurality of nodes, and information indicating evidence based on which the trust values in the trust value list were derived, the evidence was derived after the previous block of the blockchain was created; and
extracting current trust values for at least one node of the plurality of nodes from the current block.

110. A non-transitory computer-readable storage medium storing instructions which, when executed by one or more processor, cause the processor to:
obtain a current block of a blockchain, wherein the current block of the blockchain comprises the hash value of the previous block of the blockchain, a timestamp of creation of the current block, a token issued to a node that creates the previous block of the blockchain, a trust value list indicating current trust values for each of the plurality of nodes, and information indicating evidence based on which the trust values in the trust value list were derived, the evidence was derived after the previous block of the blockchain was created; and
extract current trust values for at least one node of the plurality of nodes from the current block and show blockchain information.
